(19) United States
(12) Patent Application Publication
(10) Pub. No.: US 2011/0264835 A1
(43) Pub. Date: Oct. 27, 2011

(54) Control System and Control Docking

(75) Inventors: Johnny CHEN, Santa Ana, CA (US); Ping-Shun ZEUNG, Santa Ana, CA (US)

(73) Assignee: I/O INTERCONNECT, LTD.

(21) Appl. No.: 12/764,899

(22) Filed: Apr. 21, 2010

(51) Int. Cl. G06F 13/42; G06F 13/20

(52) U.S. Cl. 710/106; 710/313

(57) ABSTRACT

An exemplary control docking is provided with a data transceiver module, a universal protocol unit, a processor unit and a universal port module. The data transceiver module is adapted for linking with a portable device through a first transmission interface for receiving an action request. The action request then is sent to the universal protocol unit and converted into an action command with specific protocol format. Then, the action command is sent to the processor unit. Subsequently, the action command is sent to the universal port module and then to a peripheral device through a second transmission interface so as to drive the peripheral device.

### BACKGROUND

1. Technical Field

The present invention generally relates to a control system and particularly, to a control system which can drive a peripheral device without the need of installing driver software.

2. Description of the Related Art

With the development of the mobile communications industry, the requirement of people from mobile phones has been more than just sending and receiving telephone calls or short message. In regard to a new generation mobile phone, not only the traditional mobile phone function is required, but also additional functions of mobile internet, document reading, calendar arrangement and high entertainment, etc. are required. Especially, a smart phone is widely accepted by public because the smart phone has an operation system platform similar to a computer and has higher hardware specification.

As to traditional smart phones, since the computer function of operation system platform is endowed, most of which allow the user to edit and read documents even create presentations. However, if wanting to output the documents or presentations for example by using a printer or a projector, the documents or presentations would be needed to be firstly sent to a personal computer and then drive peripheral devices such as the printer or projector to carry out the output of the documents or presentations from the traditional smart phones by the personal computer, such indirect output manner is seriously inconvenient for the user preferring to simple and fast solutions.

In order to solve the above-mentioned issue of inconvenience, a proposed solution is to install a driver software in the smart phone to allow the smart phone to directly drive the peripheral device and thereby achieving the purpose of outputting the documents and presentations from the smart phone. However, different brand smart phones generally have different output port specification (i.e., output port type), and moreover, different brand peripheral devices may need different driver softwares. The driver softwares needed by different peripheral devices must be installed on the smart phone in advance so as to meet the requirement of using the peripheral devices to output the documents or presentations on the smart phone at any time. However, if encountering a peripheral device being unable to support the output port specification of the smart phone, the smart phone still could not directly drive the peripheral device.

### BRIEF SUMMARY

Accordingly, the present invention is directed to a control system and a control docking which can drive a peripheral device without the need of installing additional driver software.

Specifically, a control system in accordance with an embodiment of the present invention includes a portable device, a control docking, and a peripheral device. The control docking suitable for linking with the portable device and the peripheral device through a first transmission interface and a second transmission interface respectively. Moreover, the control docking has a universal protocol unit. When the portable device outputs an action request to the control docking through the first transmission interface, the universal protocol unit drives the peripheral device through the second transmission interface without the need of installing driver software so as to respond the action request outputted by the portable device.

In one embodiment of the present invention, the portable device is for example a smart phone or a digital camera.

In one embodiment of the present invention, the peripheral device linked with the control docking is for example a printer, a scanner, a photocopier, a projector or a display, etc.

From another viewpoint, a control docking in accordance with an embodiment of the present is further provided. The control docking includes a data transceiver module, a universal protocol unit, a processor unit and a universal port module. The data transceiver module can be linked with a portable device through a first transmission interface and for receiving an action request. The action request then is sent to the universal protocol unit and converted into an action command with specific protocol format and thereafter the action command is sent to the processor unit. Subsequently, the processor unit sends the action command to the universal port module and then the action command is sent to a peripheral device through a second transport interface so as to drive the peripheral device.

In one embodiment of the present invention, the universal protocol unit is a pictbridge interface unit.

In one embodiment of the present invention, the data transceiver module includes a plurality of interface units, a detection unit, a selector and a transceiver unit. The interface units can be linked to the portable device through the first transmission interface with respective different modes. The detection unit can detect a status of each of the interface units. When the portable device selects the first transmission interface with one of the modes to establish the linking with the control docking, the detection unit will output a select signal to the selector. The selector will select one of the interface units according to the select signal to receive the action request outputted from the portable device and then send the received action request to the transceiver unit.

Since the present invention is equipped with the universal protocol unit e.g., the pictbridge interface, the present invention can drive the peripheral device to respond the action request outputted from the portable device without the need of installing driver software in advance.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a control system according to a preferred embodiment of the present invention.

FIG. 2 is a block diagram of a control docking according to a preferred embodiment of the present invention.

FIG. 3 is a block diagram of a data transceiver module according to a preferred embodiment of the present invention.

### DETAILED DESCRIPTION

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additionally items. Unless limited otherwise, the terms “connected,” “coupled,” and “mounted,” and variations thereof herein are used broadly and encompass direct and indirect connections, couplings, and mountings.

The spirit and scope of the present invention primarily is using a universal protocol to allow a portable device to drive some peripheral devices without the need of installing driver software. As a result, the portable device can control the peripheral devices through various transmission modes, and will not be subjected to the limitation of hardware specifications.

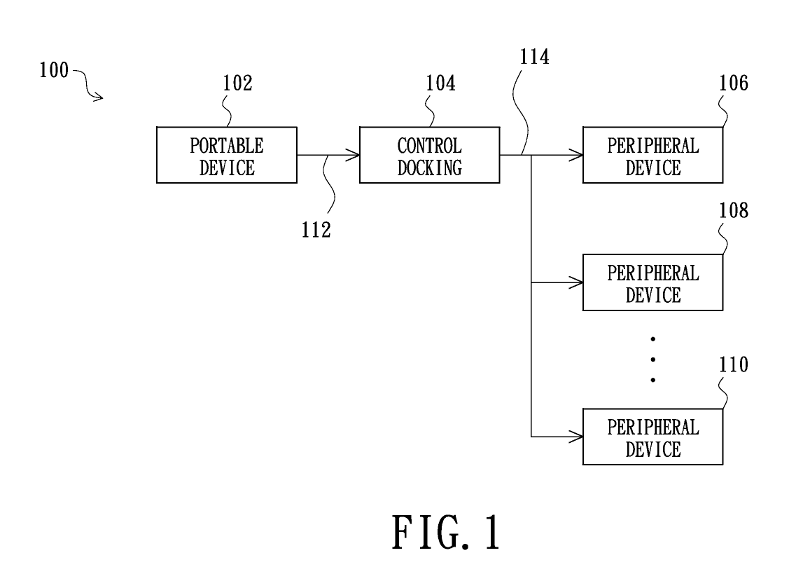

FIG. 1 is a block diagram of a control system according to a preferred embodiment of the present invention. Referring FIG. 1, the control system 100 provided by the illustrated embodiment includes a portable device 102, a control docking 104 and at least one peripheral device. In the illustrated embodiment, the control system 100 includes a plurality of peripheral devices 106, 108 and 110. In addition, the portable device 102 can be linked with the control docking 104 through a first transmission interface 112, and the control docking 104 can be linked with the peripheral devices 106, 108 and 110 through a second transmission interface 114.

In the illustrated embodiment, the portable device 102 can be a smart phone or a digital camera. The portable device 102 can be linked to the control docking 104 through the first transmission interface 112 with different transmission modes. The transmission modes includes universal serial bus (USB) transmission mode, wireless network transmission mode, or 3^{rd} generation (3G) communication protocol transmission mode, etc. Especially, when the portable device 102 selects one of the transmission modes for transmitting data, the control docking 104 would automatically switch to a corresponding operation mode for receiving information outputted by the portable device 102.

Furthermore, in the control system 100, the second transmission interface 114 can be implemented by universal serial bus interfaces. The peripheral devices 106, 108 and 110 each can be a printer, a scanner, a photocopier, a projector, or a display, etc.

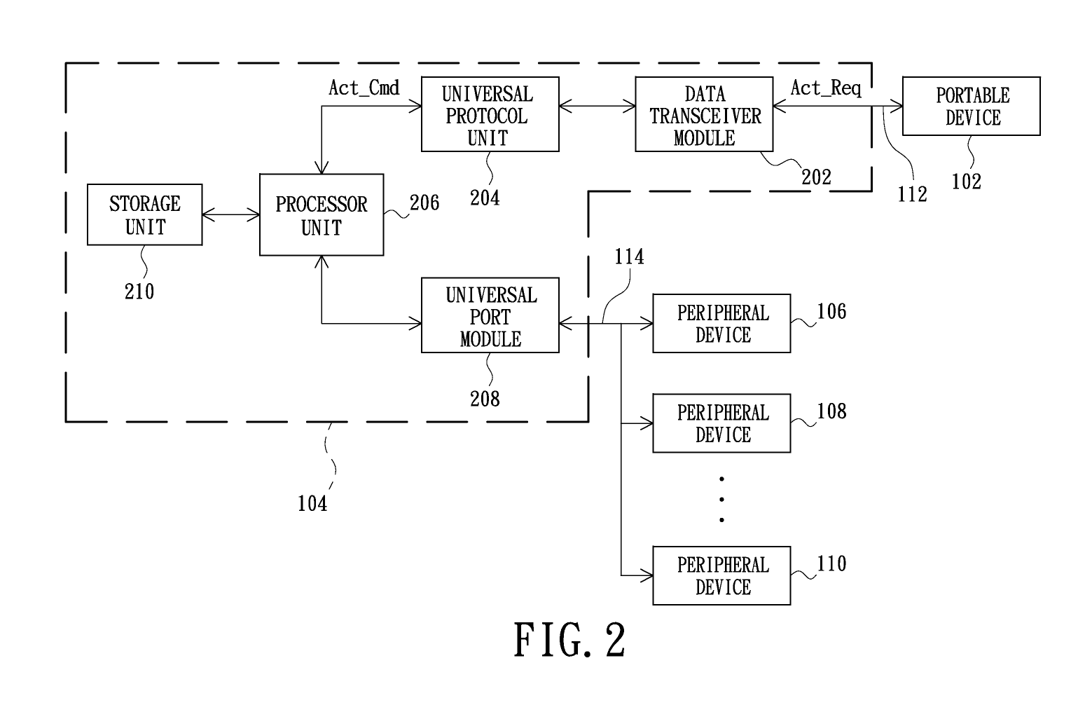

FIG. 2 is a block diagram of a control docking according to a preferred embodiment of the present invention. Referring FIG. 2, the control docking 104 includes a data transceiver module 202, a universal protocol unit 204, a processor unit 206 and a universal port module 208. The data transceiver module 202 is coupled to the universal protocol unit 204 and further can be linked with the portable device 102 through the first transmission interface 112. Besides, the processor unit 206 is coupled to the universal protocol unit 204 and the universal port module 208. Additionally, the peripheral devices 106, 108 and 110 are connected to the universal port module 208 via the second transmission interface 114.

In another embodiment, the control docking 104 can further include a storage unit 210 coupled to the processor unit 206. The storage unit 210 can be used for saving program codes and can also serve as a buffer for the control docking 104 during data processing.

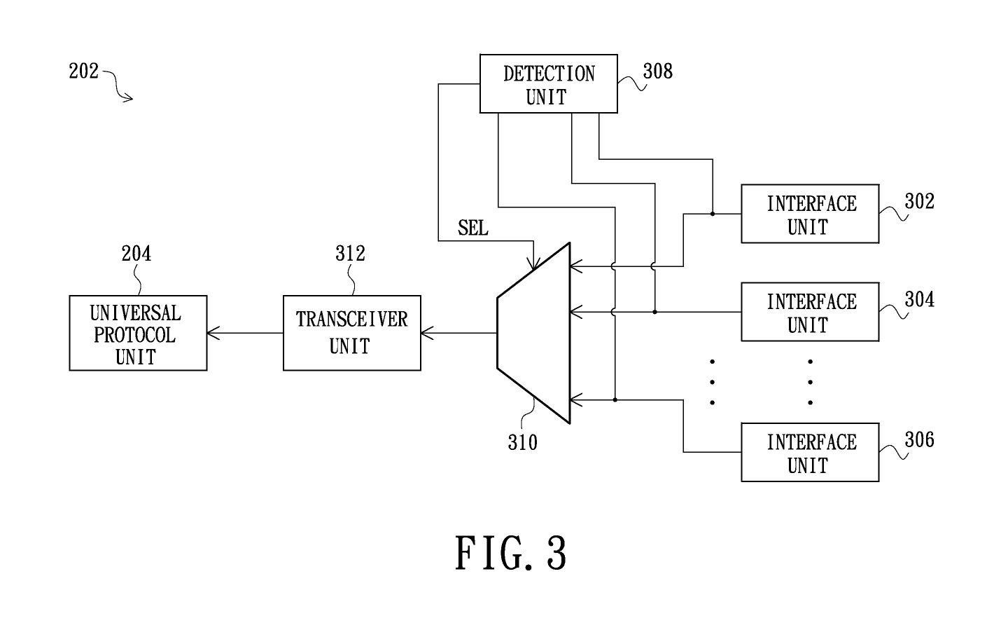

FIG. 3 is a block diagram of a data transceiver module according to a preferred embodiment of the present invention. Referring the FIG. 3, the data transceiver module 202 in the illustrated embodiment includes a plurality of interface units, e.g. 302, 304 and 306. In addition, the data transceiver module 202 further includes a detection unit 308, a selector 310 and a transceiver unit 312. The detection module 308 is coupled to all the interface units 302, 304 and 306 and the selector 310. Like wisely, the selector 310 is also coupled to all the interface units 302, 304 and 306 and the transceiver unit 312. Furthermore, the transceiver unit 312 is coupled to the universal protocol unit 204.

Referring to FIGS. 2 and 3 together, the detection unit 308 is used for detecting the status of each of the interface units 302, 304, and 306, to acquire a transmission mode selected by the portable device 102. Corresponding to the transmission modes available for the portable device 102, the interface units 302, 304 and 306 includes a universal serial bus interface unit, a wireless network interface unit and a 3G communication protocol interface unit. Therefore, the control docking 104 can link with the portable device 102 through the first transmission interface 112 with different transmission modes. When the detection unit 308 detects that the portable device 102 selects one of the transmission modes for transmitting information/data, the detection unit 308 outputs a corresponding selection signal SEL to the selector 310 according to the selection of the portable device 102. Thus, the selector 310 will select a corresponding interface unit for enable and then receive information from the portable device 102 through the enabled interface unit.

In addition, after the selector 310 receives the information from the portable device 102 through the enabled interface unit, the selector 310 then send the information to the transceiver unit 312. Afterwards, the transceiver unit 312 sends the information to the universal protocol unit 204. In another aspect, when the control docking 104 has information expected to be sent to the portable device 102, the transceiver unit 312 can send the information to the selector 310. Subsequently, the selector 310 will send the information to the portable device 102 through the enabled interface unit.

Referring to FIG. 2 again, when the portable device 102 expects to control at least one of the peripheral devices 106, 108 and 110, the portable device 102 outputs an actionrequest Act_Req to the control docking 104 via the first transmission interface 112. When the action request Act_Req is sent to the control docking 104, the action request Act_Req will be firstly received by the data transceiver module 202, and then sent to the universal protocol unit 204. In the illustrated embodiment, the universal protocol unit 204 can be implemented by a general pictbridge interface unit. After the universal protocol unit 204 receives the action request Act_Req, the action request Act_Req will be converted into a command Act_Cmd with specific format by the universal protocol unit 204.

Subsequently, the universal protocol unit 204 will send the action command Act_Cmd to the processor unit 206 for subsequent processing. After that, the processor unit 206 sends the action command Act_Cmd to the universal port module 208. In the illustrated embodiment, the universal port module 208 has at least one universal port e.g., at least one USB port, to connect the least one of the peripheral devices 106, 108 and 110 through the second transmission interface 114. After the action command Act_Cmd is sent to the universal port module 208, the action command Act_Cmd will be sent to the corresponding peripheral device via the second transmission interface 114. As a result, the peripheral devices can be driven by the portable device 102 without the need of installing additional driver software.

In actual applications, for example, the user can allow a smart phone to drive a printer for printing a document saved in the smart phone or control a projector for projecting a presentation saved in the smart phone by linking the smart phone with the control docking 104. In other applications, the user can allow the smart phone to drive a scanner for scanning a document by linking the smart phone to the control docking 104. An image file generated by scanning the document can be sent back to the smart phone through the control docking 104. At this situation, the user can review the image file by the smart phone.

In summary, the universal protocol unit such as the pictbridge interface has been widely accepted by the manufacturers and has become one of standard interfaces of many peripheral devices, accordingly the present invention can drive these peripheral devices without the need of installing additional driver software.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An control system, comprising:
a portable device;
a control docking, linked with the portable device through a first transmission interface and having a universal protocol unit; and
a peripheral device, linked with the control docking through a second transmission interface;
wherein when the portable device outputs an action request to the control docking, the universal protocol unit drives the peripheral device through the second transmission interface without the need of installing driver software to respond the action request.

2. The control system as claimed in claim 1, wherein the universal protocol unit is a pictbridge interface unit.

3. The control system as claimed in claim 1, wherein the first transmission interface comprises a plurality of transmission modes, and when the portable device selects one of the transmission modes for transmitting the action request, the control docking automatically switches to a corresponding operation mode for receiving the action request.

4. The control system as claimed in claim 3, wherein the transmission modes comprises a universal serial bus transmission mode, a wireless network transmission mode and a 3G communication protocol transmission mode.

5. The control system as claimed in claim 1, wherein the second transport interface is a universal serial bus interface.

6. The control system as claimed in claim 1, the portable device is a smart phone or a digital camera.

7. The control system as claimed in claim 1, the peripheral device is a printer, a scanner, a photocopier, a projector or a display.

8. A control docking, adapted for receiving an action request outputted by a portable device and driving a peripheral according to the action request, and comprising:
a data transceiver module, adapted for linking with the portable device through a first transmission interface to receive the action request;
a universal protocol unit, coupled to the data transceiver module for obtaining the action request from the data transceiver module and converting the action request into an action command with specific protocol format;
a processor unit, coupled to the universal protocol unit for obtaining the action command; and
a universal port module, coupled to the processor unit and for sending the action command to the peripheral device through a second transmission interface to drive the peripheral device without the need of installing driver software so as to respond the action request.

9. The control docking as claimed in claim 8, wherein the universal protocol unit is a pictbridge interface unit.

10. The control docking as claimed in claim 8, wherein the universal port module has a plurality of universal serial bus interface units.

11. The control docking as claimed in claim 8, further comprising a storage unit coupled to the processor unit.

12. The control docking as claimed in claim 8, wherein the data transceiver module comprises:
a plurality of interface units, adapted for linking with the portable device through the first transmission interface with respective different modes;
a detection unit, coupled to the interface units and for outputting a corresponding select signal when the portable device selects the first transmission interface with one of the modes to establish the linking with the control docking;
a selector, coupled to the interface units and the detection unit and for selecting one of the interface units according to the selection signal outputted by the detection unit to receive the action request; and
a transceiver unit, coupled to the selector for receiving the action request and for sending the action request to the universal protocol unit.

13. The control docking as claimed in claim 12, wherein the interface units comprises a universal serial bus interface unit, a wireless network interface unit, and a 3G communication protocol interface unit.
